(19) United States
(12) Patent Application Publication
(10) Pub. No.: US 2008/0146213 A1
(43) Pub. Date: Jun. 19, 2008

(54) APPARATUS AND METHOD FOR PROVIDING MULTICAST AND BROADCAST SERVICE IN BROADBAND WIRELESS ACCESS SYSTEM

(75) Inventors: Jun-Hyung KIM, Suwon-si (KR); Nae-Hyun LIM, Yongin-si (KR); Yong CHANG, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/872,974

(22) Filed: Oct. 16, 2007

(30) Foreign Application Priority Data
Oct. 17, 2006 (KR) 2006-100862

(51) Int. Cl. H04Q 7/20

(52) U.S. Cl. 455/422.1

(57) ABSTRACT

An apparatus and method for providing Multicast and Broadcast Service (MBS) in a Broadband Wireless Access (BWA) system are provided. The BWA system configures one or more areas of Access Control Routers (ACRs) as one Multicast and Broadcast Service (MBS) zone. A master MBS controller (MBSC) for synchronizing the MBS zone includes a divider for dividing MBS data received from a content server into a plurality of segments according to burst allocation information, a header generator for generating headers, each of which include information on an absolute broadcast time, for the segments provided from the divider and for generating MBS sub-packets by appending the generated headers and a transmitter for transmitting the MBS sub-packets generated by the header generator to one or more slave MBSCs included in the same MBS zone.

### PRIORITY

This application claims the benefit under 35 U.S.C. § 119(a) of Korean patent application filed in the Korean Intellectual Property Office on Oct. 17, 2006 and assigned Serial No. 2006-0100862, the entire disclosure of which is hereby incorporated by reference.

### BACKGROUND OF THE INVENTION

1. Field of the Invention

The present invention relates to an apparatus and method for providing a Multicast and Broadcast Service (MBS) in a Broadband Wireless Access (BWA) system. More particularly, the present invention relates to an apparatus and method for synchronizing a plurality of Radio Access Stations (RASs) existing in the same MBS zone.

2. Description of the Related Art

In general, voice services have been a primary concern in the development of communication systems. More recently, provisions of various multimedia services as well as data services are becoming important when developing the communication systems. However, a voice-based communication system has failed to satisfy user demand for such multimedia and data services due to a relatively low transmission bandwidth and an expensive service fee. Moreover, the advance of communication technologies and the growth of demand for Internet services have resulted in an increased need for a communication system capable of effectively providing the Internet services. To cope with such user demand, a Broadband Wireless Access (BWA) system has been introduced for effective provision of broadband Internet services.

In addition to voice services, the BWA system supports various data services with a high or low speed as well as multimedia application services (e.g., high-quality moving pictures). The BWA system can access a Public Switched Telephone Network (PSTN), a Public Switched Data Network (PSDN), an Internet network, an International Mobile Telecommunication (IMT) 2000 network, and an Asynchronous Transfer Mode (ATM) network in a fixed or mobile environment based on a wireless medium using a broadband spectrum (e.g., 2 GHz, 5 GHz, 26 GHz, 60 GHz, etc.). Furthermore, the BWA system can support a channel transfer rate of 2 Mbps or more. According to mobility of a Mobile Station (MS) (i.e., whether it is moving or fixed), communication environment (i.e., indoor or outdoor), and a channel transfer rate, the BWA may be classified into a broadband wireless subscriber network, a broadband mobile access network, and a high speed wireless Local Area Network (LAN).

A wireless access method of the BWA system is standardized by the Institute of Electrical and Electronics Engineers (IEEE) 802.16 group.

According to the IEEE 802.16 standard, due to a wide bandwidth, larger sized data can be transmitted in a shorter period of time in comparison with the conventional wireless technique for a voice service. In addition, a channel (or resource) can be shared by all MSs, resulting in a more effective use of the channel. Moreover, since a Quality of Service (QoS) is ensured, the MSs can receive different QoSs on the basis of service features.

IEEE 802.16 systems conform to a Multicast and Broadcast Service (MBS) standard so as to provide multicast and broadcast to a plurality of MSs. According to the MBS standard, an MBS zone can be distinguished using a Connection IDentifier (CID) or a Security Association (SA). That is, a CID and an SA are used to distinguish each MBS zone (hereinafter, also referred to as MBS_ZONE). A Base Station (BS) broadcasts MBS_ZONE information by using a Downlink Channel Descriptor (DCD) message. It can be said that the MBS_ZONE is a group of BSs using the same CID and the same SA.

An MBS may be provided by using either a single-BS access or a multi-BS access according to a service access method of an MS. When using the single-BS access method, an MS receives an MBS from one BS where the MS resides. When using the multi-BS access method, an MS receives an MBS simultaneously from two or more BSs. FIG. 1 illustrates the single-BS access method. FIG. 2 illustrates the multi-BS access method.

Referring to FIG. 2, in the multi-BS access method, when an MS is located in an overlap region between a cell providing a current service and its neighboring cell, a signal from the neighboring cell does not act as noise caused by interference but act as a signal gain as a result of Radio Frequency (RF) combining. This is called a macro diversity effect. However, the macro diversity effect can be obtained only when the same signal is transmitted from a BS that provides a current service and a BS existing in a neighboring cell. Therefore, in order to provide an MBS, all BSs existing in an MBS_ZONE have to transmit the same signal at the same time.

As such, when the MBS is provided, there is a need for a method of synchronizing a plurality of BSs existing in the same MBS_ZONE so that the same signal is transmitted from the BSs at the same time. Moreover, when the MBS_ZONE exists across areas of two or more Access Control Routers (ACRs), these ACRs existing in the same MBS_ZONE have to be synchronized.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for synchronizing Access Control Routers (ACRs) existing in the same Multicast and Broadcast Service (MBS) zone in a Broadband Wireless Access (BWA) system.

Another aspect of the present invention is to provide an apparatus and method for providing an MBS in a BWA system.

Another aspect of the present invention is to provide an apparatus and method for performing synchronization for an MBS in a BWA system.

Another aspect of the present invention is to provide an apparatus and method in which all Radio Access Stations (RASs) existing in the same MBS zone can transmit the same signal at the same time in a BWA system.

According to an aspect of the present invention, a master MBS controller (MBSC) for synchronizing an MBS zone in a BWA system which configures one or more areas of ACRs as one MBS zone is provided. The master MBSC includes a divider for dividing MBS data received from a content server into a plurality of segments according to burst allocation information, a header generator for generating headers, each of which include information on an absolute broadcast time, for the segments provided from the divider and for generating MBS sub-packets by appending the generated headers and a transmitter for transmitting the MBS sub-packets generated by the header generator to one or more slave MBSCs included in the same MBS zone.

According to another aspect of the present invention, a BWA system which configures one or more areas of ACRs as one MBS zone is provided. The BWA system includes an MBSC, corresponding to a first ACR, for dividing MBS data received from a content server into a plurality of segments, for generating MBS sub-packets by appending headers, each of which include information on an absolute broadcast time, to the divided segments, and for transmitting the MBS sub-packets to a slave MBSC and the slave MBSC, corresponding to a second ACR, for classifying the MBS sub-packets received from the master MBSC according to contents and storing the classification result, and for transmitting the MBS sub-packets to RASs connected to the second ACR in consideration of the absolute broadcast time information.

According to another aspect of the present invention, a method of operating a master Multicast and MBSC for synchronizing an MBS zone in a BWA system which configures one or more areas of ACRs as one MBS zone is provided. The method includes dividing MBS data received from a content server into a plurality of segments according to burst allocation information, generating headers, each of which include information on an absolute broadcast time, for the divided segments, generating MBS sub-packets by respectively appending the generated headers to the segments and transmitting the generated MBS sub-packets to one or more slave MBSCs existing in the same MBS zone.

According to another aspect of the present invention, a method of providing an MBS in a BWA system in which at least one of MBSCs existing in the same MBS zone operates as a master MBSC and the remaining MBSCs operate as slave MBSCs is provided. The method includes, by the master MBSC, dividing MBS data received from a content server into a plurality of segments, generating MBS sub-packets by appending headers, each of which include information on an absolute broadcast time, to the divided segments, and transmitting the MBS sub-packets to the slave MBSCs and, by the slave MBSCs, classifying the MBS sub-packets received from the master MBSC according to contents and storing the classification result and transmitting the MBS sub-packets to RASs managed by the slave MBSCS in consideration of the absolute broadcast time information.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a single-Base Station (BS) access method;

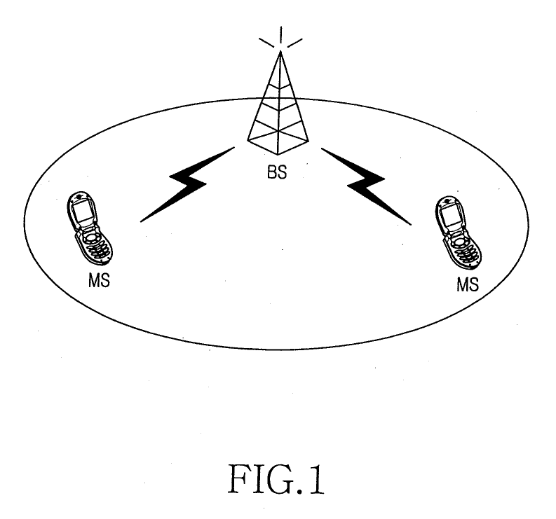

FIG. 2 illustrates a multi-BS access method;

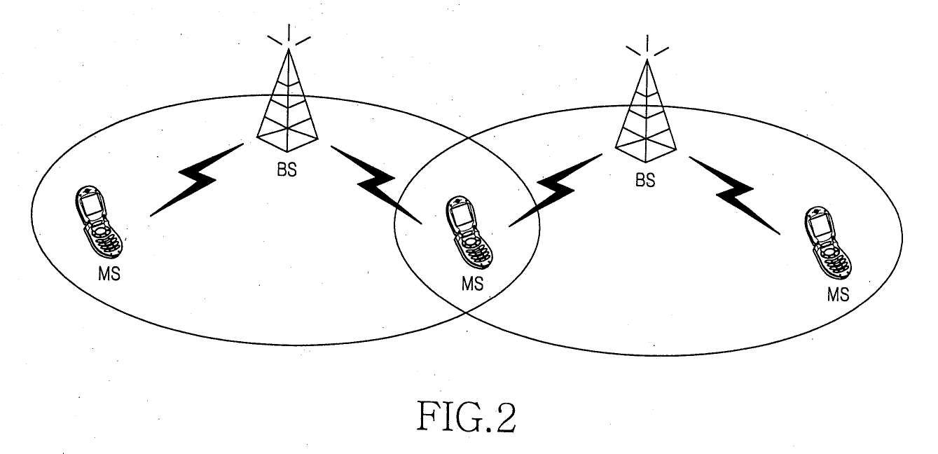

FIG. 3 illustrates a network configuration for providing a Multicast and Broadcast Service (MBS) according to an exemplary embodiment of the present invention;

FIG. 4 is a block diagram illustrating a master MBS controller (MBSC) according to an exemplary embodiment of the present invention;

FIG. 5 is a block diagram illustrating a slave MBSC according to an exemplary embodiment of the present invention;

FIG. 6 is a flowchart illustrating an operation of a master MBSC according to an exemplary embodiment of the present invention; and

FIG. 7 is a flowchart illustrating an operation of a slave MBSC according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

A technique of the present invention will be described hereinafter in that, in a Broadband Wireless Access (BWA) system providing a Multicast and Broadcast Service (MBS), synchronization is made between Access Control Routers (ACRs) existing in the same MBS zone (hereinafter, also referred to as MBS_ZONE).

In the following description, the term of Network Entity (NE) is defined based on functions, and may vary depending on standard groups or operators' intention. For example, a Radio Access Station (RAS) may be also referred to as a Base Station (BS). In addition, an Access Control Router (ACR) may be also referred to as Access Service Network-Gateway (ASN-GW).

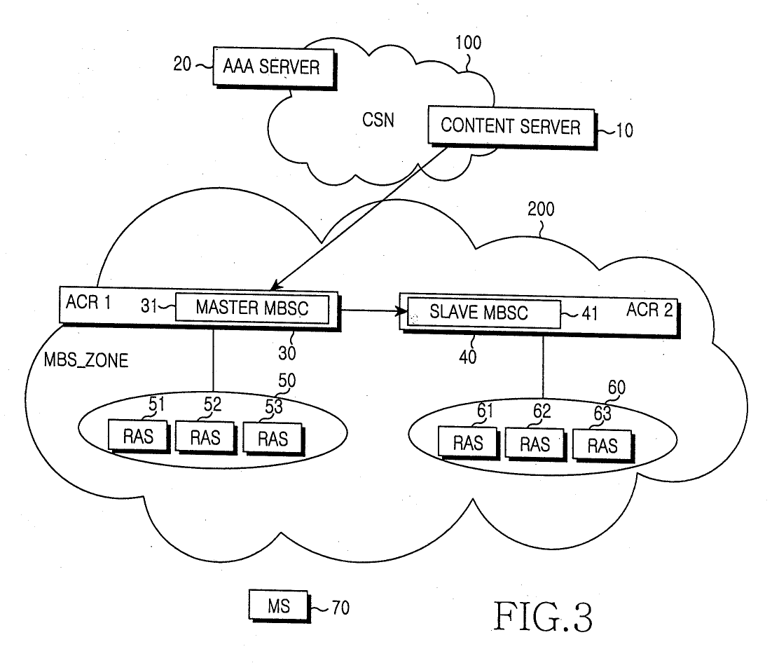

FIG. 3 illustrates a network configuration for providing an MBS according to an exemplary embodiment of the present invention.

Referring to FIG. 3, the network is divided into a Core Service Network (CSN) 100 and an Access Service Network (ASN) 200. For purposes of explanation only, it will be assumed herein that two ACRs 30 and 40 existing in the ASN 200 constitute one MBS_ZONE. The CSN 100 includes a content server 10 and an Authentication, Authorization, and Accounting (AAA) server 20. The ASN 200 includes the ACRs 30 and 40 and two groups of RASs 50 and 60 which are respectively connected to ACRs 30 and 40. The RAS group 50 includes a plurality of RASs 51, 52, 53 and the RAS group 60 includes RASs 61, 62, 63 which are respectively connected to the ACRs 30 and 40. The ACRs 30 and 40 respectively include MBS Controllers (MBSC) 31 and 41. Although the MBSCs are included in the ACRs in FIG. 3, the MBCS and the ACRs may be constructed of separate NEs.

The AAA server 20 performs authentication, authorization, and accounting functions for an MBS. The content server 10 stores MBS contents and provides the contents to the master MBSC 31 existing in the MBS_ZONE.

When a plurality of ACRs exist in the same MBS_ZONE as shown in FIG. 3, that is, when a plurality of MBSCs are present, one of them is determined as a master MBSC. The master MBSC may be predetermined by a service provider or may be determined through signaling prior to the provision of MBS. The determined master MBSC operates so as to synchronize the ACRs. For convenience of explanation, in the following description, the MBSC 31 included in the first ACR 30 will be regarded as a master MBSC, and the other MBSC 41 existing in the same MBS_ZONE will be regarded as a slave MBSC.

The master MBSC 31 included in the first ACR 30 receives MBS data from the content server 10 according to a broadcast schedule (or service guide), and performs synchronization on the MBS data. The master MBSC 31 transmits the synchronized MBS data to the slave MBSC 41, thereby synchronizing the ACRs. By performing such process, all RASs 51 to 53 and 61 to 63 are synchronized. Therefore, a Mobile Station (MS) 70 can receive the same MBS irrespective of the MBS zone of the ACRs.

Specifically, the master MBSC 31 divides the MBS data received from the content server 10 according to MBS burst allocation information. For example, if a content having a data transfer rate of 64 Kbps is broadcast, a BS (e.g., RAS) has to transmit a data burst having a size of 320 bits for every frame. Thus, the master MBSC 31 divides the MBS data to have a data size of 320 bits.

Next, the master MBSC 31 generates MBS sub-packets by generating a header of the divided MBS data, and transmits the generated MBS sub-packets to the slave MBSC 41. Further, the master MBSC 31 transmits the MBS sub-packets to the subordinate RASs 51 to 53 of the first ACR 30. The header of the MBS sub-packet includes an MBS frame sequence number that indicates a sequence number of the sub-packet and a time stamp that indicates an absolute broadcast time.

According to the MBS frame sequence number, the RASs 51 to 53 included in the first ACR 30 sort the MBS sub-packets received from the master MBSC 31. Then, the RASs 51 to 53 transmit the sorted MBS sub-packets by mapping the sub-packets to pre-allocated data burst resources at the absolute broadcast time indicated by the time stamp. As such, the RASs 51 to 53 can broadcast a desired content by using the same resource at the same time.

The slave MBSC 41 receives the MBS sub-packets from the master MBSC 31 and analyzes the headers of the MBS sub-packets so that the MBS sub-packets are classified and sorted based on contents. Further, the slave MBSC 41 transmits the MBS sub-packets to the RASs 61 to 63 included in the second ACR 40. Thereafter, according to the MBS frame sequence number, the RASs 61 to 63 sort the MBS sub-packets received from the slave MBSC 41. Then, the RASs 61 to 63 transmit the sorted MBS sub-packets by mapping the sub-packet to pre-allocated data burst resources at the absolute broadcast time indicated by the time stamp. As such, the RASs 61 to 63 included in the same MBS_ZONE can broadcast a desired content by using the same resource at the same time.

As described above, when two or more ACRs are present in the same MBS_ZONE, a specific MBSC may be designated as a master MBSC for synchronizing a broadcast time, that is, one master MBSC may generate a packet (including a time stamp) for synchronization and then may provide the packet to slave MBSCs. In this manner, all RASs 51 to 53 and 61 to 63 existing in the same MBS_ZONE can broadcast a desired content at the same absolute broadcast time.

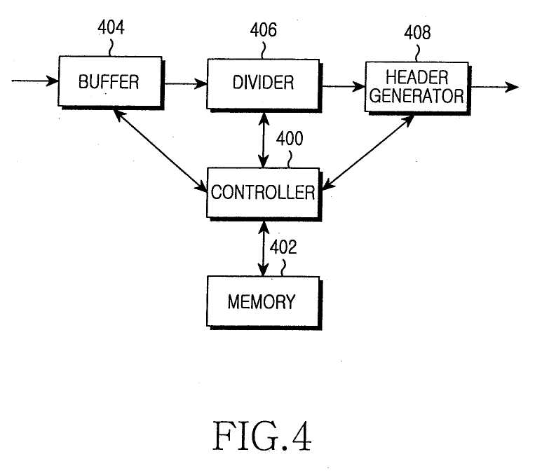

FIG. 4 is a block diagram illustrating a master MBSC 31 according to an exemplary embodiment of the present invention.

Referring to FIG. 4, the master MBSC 31 includes a controller 400, a memory 402, a buffer 404, a divider 406 and a header generator 408.

The controller 400 provides overall control to the master MBSC 31. The memory 402 stores a program for controlling overall operations of the master MBSC 31 and any data generated during the running of the program. In particular, the memory 402 stores a broadcast schedule and MBS burst allocation information.

The buffer 404 stores MBS data received from the content server 10 and outputs the MBS data for a desired content under the control of the controller 400. According to MBS burst allocation information, the divider 406 divides the MBS data stored in the buffer 404 by a specific size.

The header generator 408 generates headers for the packets divided by the divider 406 and then generates MBS sub-packets by appending the generated headers to the divided packets. The generated MBS sub-packets are transmitted to the slave MBSC 41, and are also transmitted to the subordinate RASs 51 to 53 connected to the first ACR 30.

Now, a header generation process performed by the header generator 408 will be described in detail.

In general, an Internet Protocol (IP) packet exchanged through a backbone network in the BWA system has a format as described in Table 1 below.

TABLE 1
Transport IP Header
GRE Header
User Payload

In Table 1 above, the packet exchanged through the backbone network has a format in which a transport IP header and a Generic Routing Encapsulation (GRE) header are appended to a user payload.

The GRE header has a format as described in Table 2 below.

TABLE 2

| | | | | | | |
|---|---|---|---|---|---|---|
| 0 | 0 | 1 | S | Reserved | 000 | Protocol Type |

Key = Data Path ID
Sequence Number (optional)

In exemplary embodiments of the present invention, the GRE header of Table 2 above is modified to have a format described in Table 3 below. Such modified GRE header is used in MBS synchronization.

TABLE 3

| | | | | | | | | |
|---|---|---|---|---|---|---|---|---|
| 0 | 0 | 1 | S | M | T | Reserved | 000 | Protocol Type |

Key = Data Path ID
Sequence Number (optional)
MBS Frame Sequence Number (optional)
Time Stamp (optional)

Each field of Table 3 above is described in Table 4 below.

TABLE 4

| Field | Type | Definition |
|---|---|---|
| Protocol Type | 16 bit ETHER Type | protocol type of user payload |
| Data Path ID | 32 bit Unsigned | GRE terminal ID for user |
| | | payload |
| Sequence number | 32 bit Unsigned | sequence number of user |
| | | payload packet |
| MBS Frame | 32 bit Unsigned | data segment number of content |
| Sequence number | | |
| Time Stamp | 32 bit Unsigned | packet transmission time of |
| | | RAS |

As mentioned above, the packet (i.e., MBS sub-packet) exchanged between MBSCs includes an MBS frame sequence number and a time stamp. For example, the MBS frame sequence number may be formed by the sum of a content ID and a data segment number as expressed in the following Equation.

MBS Frame Sequence Number=Content ID+Data Segment Number

The time stamp is set to an absolute time at which a RAS transmits an MBS sub-packet.

In Table 3 above, a flag field ‘M’ indicates whether the MBS frame sequence number field exists or not, and a flag field ‘T’ indicates whether a time stamp field exists or not. The slave MBSC 41 analyzes these flag values of the GRE header so as to determine whether received packets are MBS sub-packets. If the received packets are the MBS sub-packets, the MBS sub-packets may be stored after being classified and sorted based on contents.

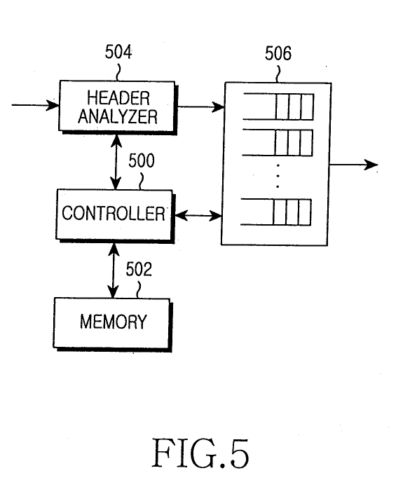

FIG. 5 is a block diagram illustrating a slave MBSC 41 according to an exemplary embodiment of the present invention.

Referring to FIG. 5, the slave MBSC 41 includes a controller 500, a memory 502, a header analyzer 504 and a data sorter 506.

The controller 500 provides overall control to the slave MBSC 41. The memory 502 stores a program for controlling overall operations of the slave MBSC 41 and any data generated during the running of the program. In particular, the memory 502 stores a broadcast schedule and MBS burst allocation information.

The header analyzer 504 analyzes headers of the MBS sub-packets received from the master MBSC 31 and provides analyzed header information to the controller 500. Further, the header analyzer 504 outputs the MBS sub-packets, of which headers have been analyzed, to the data sorter 506.

The controller 500 reads a content ID and a data segment number of the MBS sub-packet received from the header analyzer 504 according to header information. Then, under the control of the controller 500, the received MBS sub-packets are stored after being classified and sorted based on contents.

The data sorter 506 includes queues for storing contents. The MBS sub-packets provided from the header analyzer 504 are stored in corresponding queues under the control of the controller 500. The stored MBS sub-packets are transmitted to the RASs 61 to 63 connected to the second ACR 40 at a corresponding transmission time under the control of the controller 500. The time for transmitting the MBS sub-packets from the slave MBSC 41 to the RASs 61 to 63 may be determined based on a broadcast time recorded in the headers of the MBS sub-packets.

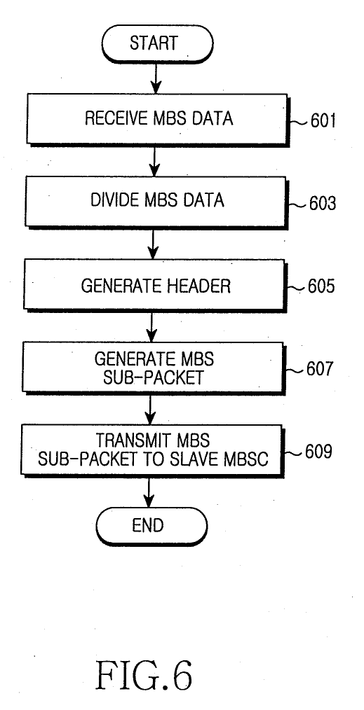

FIG. 6 is a flowchart illustrating an operation of the master MBSC 31 according to an exemplary embodiment of the present invention.

Referring to FIG. 6, in step 601, MBS data of a desired content is received from the content server 10 according to a broadcast schedule. Upon receiving the MBS data, in step 603, the received MBS data is divided by a specific size according to MBS burst allocation information.

In step 605, a header is generated for each of the divided segments. Each header may include a segment sequence number which is unique for each of contents, a packet transmission time (absolute time) of an RAS, and so on.

In step 607, MBS sub-packets are generated by appending the generated headers to the divided segments. In step 609, the generated MBS sub-packets are transmitted to slave MBSCs existing in the same MBS_ZONE.

As such, packets for synchronizing a broadcast time are generated and then are transmitted to the slave MBSCs existing in the same MBS_ZONE.

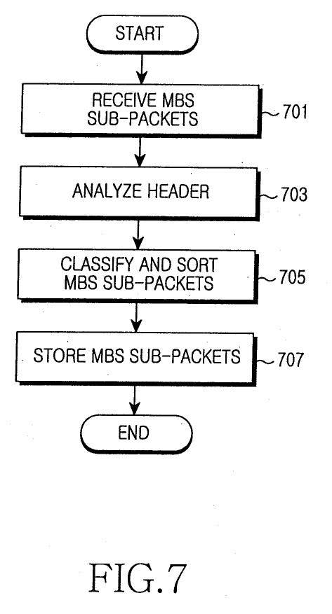

FIG. 7 is a flowchart illustrating an operation of the slave MBSC 41 according to an exemplary embodiment of the present invention.

Referring to FIG. 7, in step 701, MBS sub-packets are received from the master MBSC 31. Upon receiving the MBS sub-packets, headers of the received MBS sub-packets are analyzed in step 703. Herein, each header may include a segment sequence number which is unique for each of contents, a packet transmission time of a RAS, and so on. That is, a content ID and a segment sequence number of a corresponding MBS sub-packet are determined through a header analysis.

In step 705, according to the determination result, the MBS sub-packets are classified based on contents, and the classified MBS sub-packets are sorted based on sequence numbers. In step 707, the classified MBS sub-packets are stored in corresponding queues. The stored MBS sub-packets are transmitted to the RASs 61 to 63 connected to the second ACR 40.

According to the exemplary flows described in FIGS. 6 and 7, the MBS sub-packets generated by the master MBSC 31 are equally transmitted to RASs existing in the same MBS_ZONE, and thus all RASs existing in the same MBS_ZONE can broadcast a desired content to an MS at the same absolute broadcast time. In other words, all RASs existing in the same MBS_ZONE transmit the MBS sub-packets received from an ACR at the same time according to a time stamp.

According to exemplary embodiments of the present invention, synchronization can be achieved between ACRs existing in the same MBS_ZONE in a Broadband Wireless Access (BWA) system providing a Multicast and Broadcast Service (MBS). As such, since zones of a plurality of ACRs can be configured as one MBS_ZONE when the ACRs are synchronized, an MBS_ZONE can be configured in a further flexible manner.

The above description is meant for exemplary purposes only and is not meant to limit the scope of the invention. For example, the message formats of Tables 1 to 4 are described only for explanation purpose, and thus may have various forms according to designers' intention. Therefore, the scope of the invention is defined not by the detailed description of the invention but by the appended claims and their equivalents, and all differences within the scope will be construed as being included in the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A master Multicast and Broadcast Service Controller (MBSC) for synchronizing a Multicast and Broadcast Service (MBS) zone in a Broadband Wireless Access (BWA) system which configures one or more areas of Access Control Routers (ACRs) as one MBS zone, the master MBSC comprising:
a divider for dividing MBS data received from a content server into a plurality of segments according to burst allocation information;
a header generator for generating a plurality of headers, each of which includes information on an absolute broadcast time, respectively for the plurality of segments provided from the divider and for generating MBS sub-packets by appending the generated headers to the segments; and
a transmitter for transmitting the MBS sub-packets generated by the header generator to one or more slave MBSCs included in the same MBS zone.

2. The master MBSC of claim 1, wherein the master MBSC corresponds in a one-to-one manner with one of the ACRs and operates as the master MBSC in an MBS zone comprising at least one additional MBSC.

3. The master MBSC of claim 1, wherein the header of the MBS sub-packet includes at least one of the absolute broadcast time and a unique sequence number of content.

4. The master MBSC of claim 3, wherein the unique sequence number comprises a sum of a content IDentifier (ID) and a segment sequence number.

5. The master MBSC of claim 1, further comprising a memory for storing at least one of a broadcast schedule and burst allocation information of content.

6. A Broadband Wireless Access (BWA) system which configures one or more areas of Access Control Routers (ACRs) as one Multicast and Broadcast Service (MBS) zone, the system comprising:
a master MBS controller (MBSC), corresponding to a first ACR, for dividing MBS data received from a content server into a plurality of segments, for generating MBS sub-packets by appending headers, each of which includes information on an absolute broadcast time, to the divided segments, and for transmitting the MBS sub-packets to a slave MBSC; and
the slave MBSC, corresponding to a second ACR, for classifying the MBS sub-packets received from the master MBSC through a header analysis, and for transmitting the MBS sub-packets to one or more Radio Access Stations (RASs) connected to the second ACR in consideration of the absolute broadcast time information.

7. The BWA system of claim 6, wherein the master MBSC transmits the MBS sub-packets to one or more RASs connected to the first ACR.

8. The BWA system of claim 7, wherein the one or more RASs, connected to the first ACR, receive the MBS sub-packets from the master MBSC and transmit the MBS sub-packets to a Mobile Station (MS) by using a data burst resource allocated to the broadcast time indicated by the headers.

9. The BWA system of claim 6, wherein the one or more RASs, connected to the second ACR, receive the MBS sub-packets from the slave MBSC and transmit the MBS sub-packets to an MS by using a data burst resource allocated to the broadcast time indicated by the headers.

10. The BWA system of claim 6, wherein the master MBSC comprises:
a divider for dividing the MBS data received from the content server into the plurality of segments according to burst allocation information;
a header generator for generating the headers, each of which includes information on the absolute broadcast time, for the segments provided from the divider and for generating the MBS sub-packets by appending the generated headers to the segments; and
a transmitter for transmitting the MBS sub-packets generated by the header generator to one or more slave MBSCs included in the same MBS zone.

11. The BWA system of claim 6, wherein the header of the MBS sub-packet includes at least one of the absolute broadcast time and a unique sequence number of content.

12. The BWA system of claim 11, wherein the unique sequence number comprises a sum of a content IDentifier (ID) and a segment sequence number.

13. A method of operating a master Multicast and Broadcast Service Controller (MBSC) for synchronizing a Multicast and Broadcast Service (MBS) zone in a Broadband Wireless Access (BWA) system which configures one or more areas of Access Control Routers (ACRs) as one MBS zone, the method comprising:
dividing MBS data received from a content server into a plurality of segments according to burst allocation information;
generating headers, each of which includes information on an absolute broadcast time, for the divided segments;
generating MBS sub-packets by respectively appending the generated headers to the segments; and
transmitting the generated MBS sub-packets to one or more slave MBSCs existing in the same MBS zone.

14. The method of claim 13, wherein the master MBSC and the slave MBSC each correspond in a one-to-one manner with one of the ACRs, and the master MBSC operates as the master MBSC in an MBS zone comprising at least one additional MBSC.

15. The method of claim 13, wherein the header of the MBS sub-packet includes at least one of the absolute broadcast time and a unique sequence number of content.

16. The method of claim 15, wherein the unique sequence number comprises a sum of a content ID and a segment sequence number.

17. The method of claim 13, further comprising storing at least one of a service guide and burst allocation information of content.

18. A method of operating a slave Multicast and Broadcast Service Controller (MBSC) in a Broadband Wireless Access (BWA) system in which at least one of MBSCs existing in the same Multicast and Broadcast Service (MBS) zone operates as a master MBSC and the remaining MBSCs operate as slave MBSCs, the method comprising:
receiving MBS sub-packets, in which a broadcast time is stamped, from the master MBSC;
classifying and sorting the MBS sub-packets according to header information; and
transmitting the sorted MBS sub-packets to Radio Access Stations (RASs) managed by the slave MBSC in consideration of an absolute broadcast time.

19. The method of claim 18, wherein the header of the MBS sub-packet includes at least one of the absolute broadcast time and a unique sequence number of content.

20. The method of claim 19, wherein the unique sequence number comprises a sum of a content IDentifier (ID) and a segment sequence number.

21. A method of providing a Multicast and Broadcast Service (MBS) in a Broadband Wireless Access (BWA) system in which at least one of MBSC controllers (MBSCs) existing in the same MBS zone operates as a master MBSC and the remaining MBSCs operate as slave MBSCs, the method comprising:
dividing MBS data received from a content server into a plurality of segments, generating MBS sub-packets by appending headers, each of which includes information on an absolute broadcast time, to the divided segments, and transmitting the MBS sub-packets to the slave MBSCs, by the master MBSC; and
classifying the MBS sub-packets received from the master MBSC according to header information, and transmitting the MBS sub-packets to Radio Access Stations (RASs) managed by the slave MBSCs in consideration of the absolute broadcast time information, by the slave MBSCs.

22. The method of claim 21, further comprising transmitting, by the master MBSC, the MBS sub-packets to RASs managed by the master MBSC.

23. The method of claim 22, further comprising transmitting, by the RASs managed by the master MBSC and the RASs managed by the slave MBSCs, the MBS sub-packets to a Mobile Station (MS) according to a broadcast time indicated by the headers at the same time by using the same burst resource.

24. The method of claim 21, wherein the header of the MBS sub-packet includes at least one of the absolute broadcast time and a unique sequence number of content.

25. The method of claim 24, wherein the unique sequence number comprises a sum of a content IDentifier (ID) and a segment sequence number.
